(19) United States
(12) Patent Application Publication
(10) Pub. No.: US 2012/0265881 A1
(43) Pub. Date: Oct. 18, 2012

(54) PROVISIONING DATA CENTER RESOURCES

(76) Inventors: Yuan Chen, Sunnyvale, CA (US); Anshul Gandhi, Mountain View, CA (US); Daniel Juergen Gmach, Palo Alto, CA (US); Chris D. Hyser, Victor, NY (US); Martin Arlitt, Calgary (CA); Manish Marwah, Palo Alto, CA (US); Cullen E. Bash, Los Gatos, CA (US)

(21) Appl. No.: 13/086,964

(22) Filed: Apr. 14, 2011

(51) Int. Cl. G06F 15/173

(52) U.S. Cl. 709/226

(57) ABSTRACT

Example methods, apparatus and articles of manufacture to provision data center resources are disclosed. An example method includes provisioning a first portion of data center resources to operate during time intervals based on a base workload for the respective time intervals, the base workload being based on data patterns of a data center and configuring a second portion of the data center resources to operate when an actual workload exceeds a threshold corresponding to the base workload.

### BACKGROUND

Many organizations utilize data centers to provide centralized computational and/or storage services. Data centers are relatively expensive to operate as a result of costs to power and cool data center resources. Data centers resources include, for example, servers, storage components, network switches, processors, and/or controllers. As demand for data center resources increases, the energy to operate data center resources can increase.

### BRIEF DESCRIPTION OF THE DRAWINGS

FIGS. 1A, 1B, and 1C are schematic illustrations of an example system and/or example resource manager constructed pursuant to the teachings of this disclosure to provision data center resources.

FIGS. 2A and 2B show the example resource manager of FIGS. 1A and 1B provisioning data center resources.

FIGS. 3 and 4 are graphs reflecting example operational performance for the example resource manager of FIGS. 1A, 1B, and 2.

FIGS. 5A, 5B, and 6 are flowcharts representative of example machine-accessible instructions, which may be executed to implement the example resource manager and/or system of FIGS. 1A, 1B, and 2.

FIG. 7 is a schematic illustration of an example processor platform that may be used and/or programmed to execute the example processes and/or the example machine-accessible instructions of FIGS. 5A, 5B, and 6 to implement any or all of the example methods, apparatus and/or articles of manufacture described herein.

### DETAILED DESCRIPTION

Data centers are commonly used by organizations (e.g., governments, corporations, companies, network providers, service providers, cloud computing operators, etc.) for computing and storage resources (e.g. data center resources). Data centers resources include, for example, servers, processors, network switches, memories, and/or controllers. Data center resources consume relatively large amounts of power to operate. For example, the Environmental Protection Agency projects that energy consumption by data centers in the United States could exceed 100 billion kilowatt hours (kWh) in 2011, which could cost data center operators an estimated $7.4 billion. Rising energy costs, regulatory power requirements, and social concerns regarding green house gas emissions have made reducing power consumption a priority for data center operators.

Many data center operators use various methods to manage data center workload capacity and power through static or dynamic provisioning of data center resources. A workload includes requests from users to access and/or utilize resources in a data center. A workload can include and/or utilize, for example, data center bandwidth, processing power, a number of servers, server space, and/or memory. As the dynamics of computing change from centralized workstations to distributive computing via data centers, data centers are processing increasingly larger workloads.

Some data centers implement a static configuration that assumes there is a stationary demand pattern. These data centers provision resources as some percentage of peak demand and do not change the provisioning. However, time-varying demand patterns of resource usage can result in data centers being over-provisioned (e.g., allocating too many resources) during some time periods and being under-provisioned (e.g., allocating too few resources) during other time periods. During instances of over-provisioning, the data centers generally consume excess power. Additionally, during instances of under-provisioning, data center resources may violate service level agreements (SLAs) resulting in lost business revenue.

Other data centers may use dynamic and/or real time solutions that use reactive routines and/or algorithms to monitor workload demands and turn data center resources off/on in response to an actual workload. While these dynamic and/or real time solutions can potentially save power consumption by correlating available resources to actual workloads, the relatively frequent provisioning of the resources can make the data centers unstable. For example, frequently provisioning resources may cause a loss of service. Additionally, frequent provisioning of resources can increase data center overhead (e.g., time to provision resources, operator time to manage the provisioning, and/or system diagnostics to maintain data center stability) and/or can result in frequent power cycling of data center resources, thereby causing wear on the resources. The wear may result in service outages and/or increased costs associated with frequently repairing and/or replacing the data center resources. Further, these dynamic and/or real time solutions are sometimes not preferred by data center operators because the operators want to verify and/or approve new provisioning configurations of data center resources.

Example methods, apparatus, and/or articles of manufacture disclosed herein provide for greater efficiency of data centers by identifying a representative workload pattern for a data center, provisioning a first portion of the data center resources for a base workload for time intervals based on the representative workload pattern, and configuring a second portion of the data center resources to be on standby to process excess workloads. A representative workload pattern is a mean, average, and/or other baseline pattern of measured and/or actual historical data center resource usage.

The example methods, apparatus, and articles of manufacture disclosed herein determine a base workload from a representative workload pattern by determining a number of resources to provision that can process a majority (e.g., 60%, 75%, 90%, etc.) of the previously measured workload. A base workload specifies a number and/or an amount of resources to be provisioned during a time interval. An workload includes, for example, a number of users, request rates, a number of transactions per second, etc. Some such example methods, apparatus, and/or articles of manufacture disclosed herein create base workloads that are substantially constant during respective time intervals so that additional data center resources are not provisioned during time intervals corresponding to the baseline usage patterns. In other words, example methods, apparatus, and/or articles of manufacture disclosed herein provision data center resources at the start of each time interval based on a base workload specified for that time interval and additional resources may not be brought online during that interval.

Example methods, apparatus, and/or articles of manufacture disclosed herein utilize patterns of data centers and/or patterns in workloads to determine representative workload patterns for the data centers. Example methods, apparatus and/or articles of manufacture disclosed herein resolve a representative workload pattern with a routine that reduces a number of time intervals throughout a period of interest, thereby reducing a number of times data center resources are provisioned or shut down during a period (e.g., an hour, a day, a week, etc.). The example routine incorporates, for example, costs and/or risks associated with provisioning data center resources and/or under-provisioning such resources.

Example methods, apparatus, and/or articles of manufacture disclosed herein reduce data center energy consumption by having a first portion of data center resources provisioned to manage a base workload at relatively coarse time intervals (e.g., hours) and having a second portion of data center resources that are configured to be reactive to manage excess workloads that exceed the base workload and/or a threshold based on the base workload. In this manner, the first portion of the data center resources are configured to manage long term patterns of workload while the second portion of the data center resources are configured to manage relatively brief spikes in workload from, for example, flash crowds, service outages, holidays, etc.

The provisioning of data center resources by example methods, apparatus, and/or articles of manufacture disclosed herein allocates a number of data center resources needed to process a workload, thereby meeting SLA requirements while reducing the number of times data center resources are activated and/or deactivated. Reducing the number of times data center resources are activated/deactivated reduces wear, energy, repair time, and/or resource replacement costs. By reducing an amount of provisioning of data center resources, example methods, apparatus and/or articles of manufacture disclosed herein ensure that data centers remain stable and within configurations approved by data center operators. Additionally, example methods, apparatus, and/or articles of manufacture disclosed herein are able to adapt to any workload demand pattern and/or data center environment. Further, example methods, apparatus, and/or articles of manufacture disclosed herein may be customized by data center operators to accommodate different structures of data centers and/or beneficial balances between power consumption and SLA violations.

While example methods, apparatus, and/or articles of manufacture disclosed herein are described in conjunction with data center resources including, for example servers, example methods, apparatus and/or articles of manufacture disclosed herein may provision any type of computing resource including, for example, virtual machines, processors, network switches, controllers, memories, databases, computers, etc. Further, while example methods, apparatus and/or articles of manufacture disclosed herein are described in conjunction with an organization, example methods, apparatus and/or articles of manufacture disclosed herein may be implemented for any type of owner, leaser, customer, and/or entity such as network providers, service providers, cloud computing operators, etc.

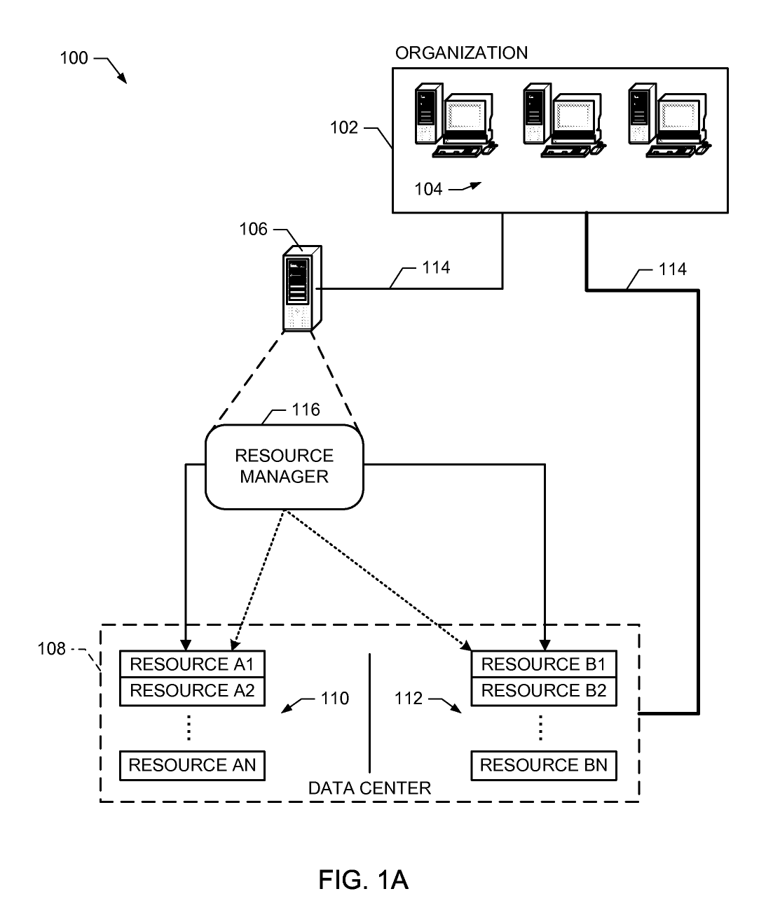

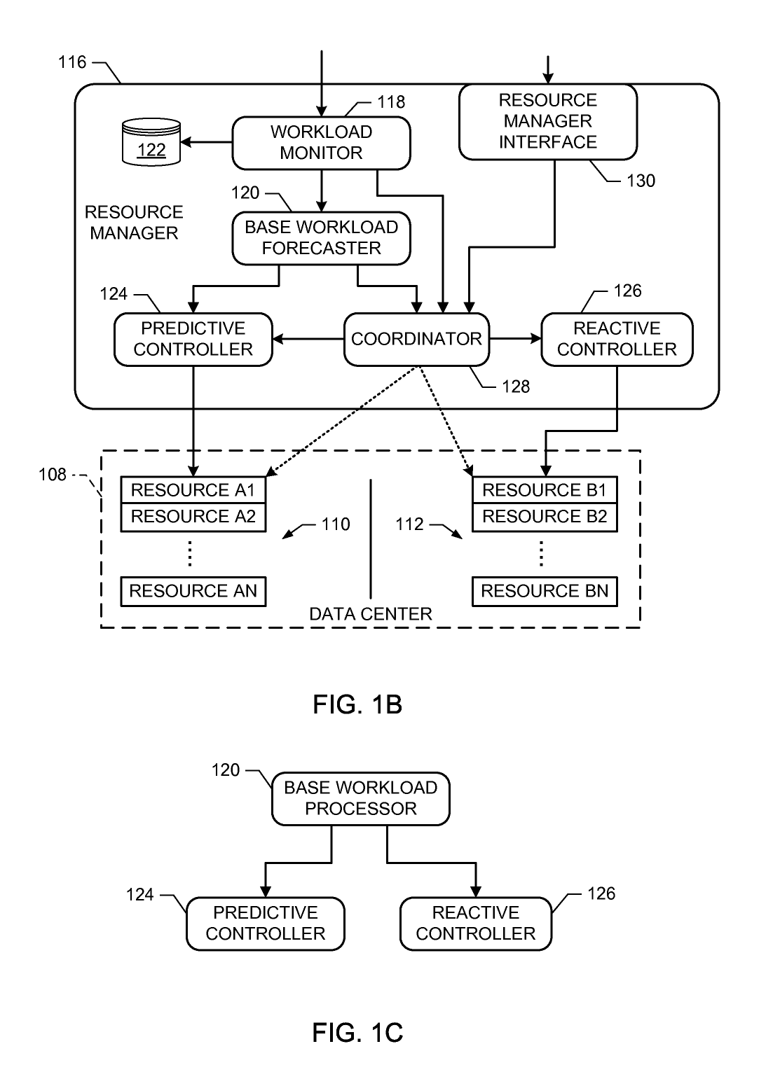

FIG. 1A shows an example system 100 constructed in accordance with the teachings of this disclosure to provision data center resources. The example system of FIG. 1A includes an organization 102, which may be a government, corporation, school, university, company, etc. In other examples, the organization 102 may be replaced by a network provider and/or a service provider accessed by individual users. The example organization 102 of FIG. 1A includes workstations 104 (e.g., computers and/or hosts) that enable users to interface with applications and/or data associated with, for example, the organization 102. The example workstations 104 may be implemented by any type of computing device including, for example, a personal computer, a server, a laptop, a smartphone, a smartpad, etc.

The example organization 102 illustrated in FIG. 1A includes and/or is associated with a server 106 to couple the workstations 104 to a data center 108. The example data center 108 is included in, owned by, and/or associated with the example organization 102. In some examples, the data center 108 may be associated with the organization 102 but physically separate from the workstations 104. In other examples, the data center 108 may be separate from the organization 102. In these other examples, the organization 102 may, for example, subscribe, lease, and/or purchase access to the data center 108.

The example data center 108 of FIG. 1A includes a first portion of resources 110 and a second portion of resources 112. The first portion of resources 110 corresponds to resources that are active to manage and/or process workloads from, for example, the organization 102. The second portion of the resources 112 corresponds to resources that are activated to manage and/or process excess workloads (e.g., workloads larger than base workload for the corresponding interval).

In the illustrated example, the first portion of resources 110 includes resources A1-AN and the second portion of resources 112 includes resources B1-BN. The resources A1-AN and B1-BN include any amount and/or type(s) of server, blade server, processor, computer, memory, database, controller, and/or network switch that can be provisioned. Based on representative workload patterns and/or calculated base workloads, resources may be exchanged between the two portions 110 and 112. Thus, the example portions 110 and 112 represent logical groups of the resources A1-AN and B1-BN based on provisioning. For example, the resource A1 may be physically adjacent to the resource B1 (e.g., adjacent blade servers within a server rack) while the resource A2 is located 3,000 miles from the resources A1 and B1. In other examples, the portions 110 and 112 may also represent physical groupings of the resources A1-AN and B1-BN. There may be the same or different numbers and/or types of resources within the first portion of resources 110 and the second portion of resources 112.

The example server 106 and the example data center 108 of FIG. 1A are communicatively coupled to the workstations 104 via a network 114 (e.g., the Internet, a Local Area Network, etc.). The example server 106 of FIG. 1A receives request(s) from the workstation(s) 104 to access resources (e.g., the resources A1-AN) within the data center 108 via the network 114. In response, the example server 106 determines which resource(s) within the example data center 108 are to be coupled to the workstation(s) 104 and reply(ies) to the workstation(s) 104 indicating the selected resource(s). The example server 106 also message(s) to the selected resource(s) to enable communication with and/or usage by the workstation(s) 104. The workstation(s) 104 may then use the identity of the resource(s) to communicatively couple to the resource(s) via the network 114. Alternatively, the workstation(s) 104 may communicatively couple to the resource(s) A1-AN without accessing the server 106. In these alternative examples, the data center 108 may determine to which resource(s) A1-AN (or B1-BN) the workstation(s) 104 are to be communicatively coupled and/or the resource(s) may communicate with the server 106 for authorization to cooperate with the workstation(s) 104.

To provision the example portions of resources 110 and 112 within the example data center 108, the example server 106 of FIG. 1A includes a resource manager 116. The example resource manager 116 collects workload data patterns from, for example, the organization 102 and uses the data patterns to create a representative workload pattern for provisioning resources within the data center 108. While the example resource manager 116 is shown as being included within the server 106, in other examples, the resource manager 116 is included within a separate processor communicatively coupled to the network 114 and/or the workstations 104. In yet other examples, the resource manager 116 may be included within the workstations 104 and/or within the data center 108.

To collect workload data patterns, the example resource manager 116 of FIG. 1B includes a workload monitor 118. The example workload monitor 118 probes the organization 102 to collect hierarchal workload data patterns for the workstations 104. The example workload monitor 118 may collect the data patterns by determining an amount of bandwidth (e.g., demand) of the network 114 used by the workstations 104. In other examples, the workload monitor 118 may determine an amount of data transfer associated with the workstations 104 and/or the data center 108. In yet other examples, the workload monitor 118 may determine a number of requests to access resources within the data center 108.

The workload monitor 118 of the illustrated example collects workload data patterns over time periods. For example, the workload monitor 118 may monitor workload data patterns during 24 hour time periods. In other examples, the workload monitor 118 may monitor data patterns during weekly time periods, bi-weekly time periods, monthly time periods, etc. By collecting data patterns over time periods, a base workload forecaster 120 (e.g., a processor) can characterize the workload data patterns for a same time of day. For example, workload data patterns collected over a plurality of 24 hour time periods by the workload monitor 118 can be compared by the base workload forecaster 120 to determine a 24 hour representative workload pattern. Alternatively, the workload monitor 118 may probe workloads of the workstations 104 during different time periods. In these alternative examples, the example base workload forecaster 120 resolves and/or normalizes the different time periods to determine a representative workload pattern.

After collecting workload data patterns, the example workload monitor 118 of FIG. 1B stores the data patterns to a data pattern database 122. The data pattern database 122 stores workload data patterns so that the base workload forecaster 120 may use the collected workload data patterns to determine a representative workload pattern. In some examples, data center operators access the data pattern database 122 to view collected (e.g., historical) data patterns. The data pattern database 122 may be implemented by, for example, storage disk(s) disk array(s), tape drive(s), volatile and/or non-volatile memory, compact disc(s) (CD), digital versatile disc(s) (DVD), floppy disk(s), read-only memory (ROM), random-access memory (RAM), programmable ROM (PROM), electronically-programmable ROM (EPROM), electronically-erasable PROM (EEPROM), optical storage disk(s), optical storage device(s), magnetic storage disk(s), magnetic storage device(s), cache(s), and/or any other storage media in which data is stored for any duration.

To determine a representative workload pattern, the example resource manager 116 of FIG. 1B includes the base workload forecaster 120. The example base workload forecaster 120 uses collected workload data patterns to determine repeating (e.g., hourly, daily, weekly, seasonal, etc.) patterns. The example base workload forecaster 120 analyzes the workload data patterns to identify relatively short-term and/or long-term workload characteristics.

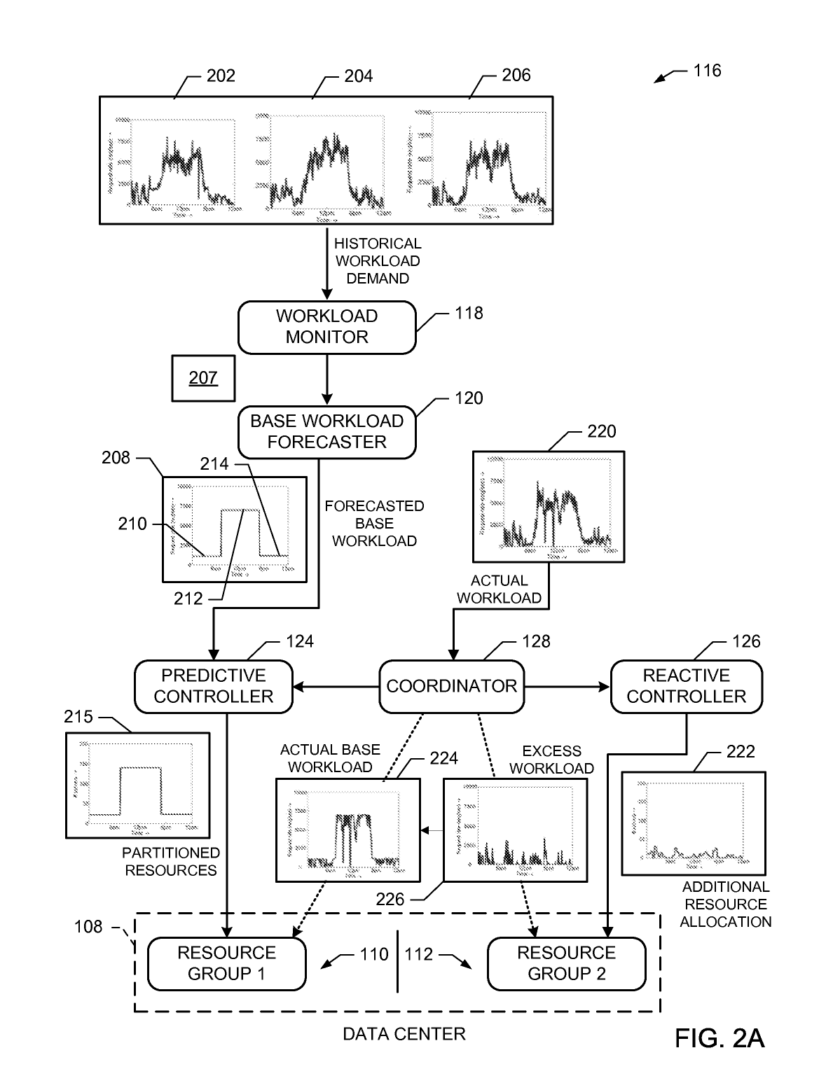

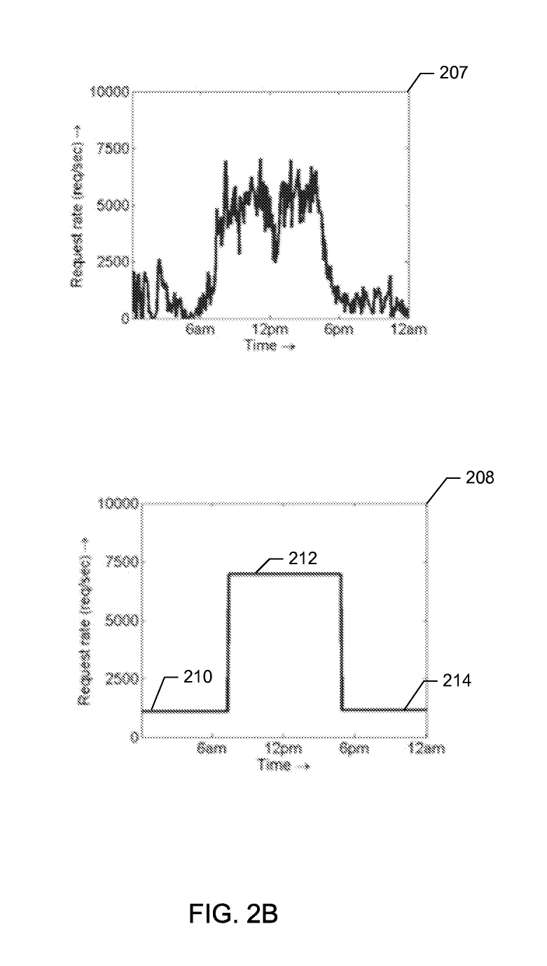

To determine a representative workload pattern from among a plurality of workload data patterns, the example base workload forecaster 120 performs, for example, a periodicity analysis. An example periodicity analysis includes a time-series analysis of workload data patterns to identify repeating workload patterns within a time period. The example base workload forecaster 120 performs the periodicity analysis using a Fast Fourier Transform (FFT). The base workload forecaster 120 then determines a representative demand using an average and/or a weighted average of historical workload data. The weights for the weighted average may be selected using linear regression to reduce a sum-squared error of projection of the representative workload pattern. An example of the base workload forecaster 120 using workload data patterns to determine a representative workload pattern is described in conjunction with FIG. 2A.

After determining a representative workload pattern, the example base workload forecaster 120 determines a number of time intervals. The example base workload forecaster 120 determines a number of time intervals to determine when the first and second portions of resources 110 and 112 are to be provisioned based on the representative workload pattern. In other examples, the base workload forecaster 120 determines a number of time intervals and determines a corresponding base workload for each time interval based on corresponding collected workload data patterns. The example base workload forecaster 120 of such other examples then combines the base workloads to create a representative workload pattern for a time period.

The example base workload forecaster 120 of FIG. 1B reduces a number of provisioning time intervals to decrease a number of times the resources A1-AN and B1-BN are provisioned, thereby increasing stability of the data center 108 and reducing energy costs. The example base workload forecaster 120 balances a goal of reducing time intervals with a goal of correlating resource capacity to projected demand. By balancing the time interval goal with the resource capacity goal, the example base workload forecaster 120 is able to provision the resources A1-AN and B1-BN so that a majority of the projected workload is processed by the first portion of resources 110 while reducing the number of times resources are added to and/or removed from the first portion 110.

In an example of determining a number of provisioning intervals, the example base workload forecaster 120 uses a dynamic programming solution (e.g., a routine, function, algorithm, etc.). An example equation (1) is shown below to illustrate an example method of summing variances of projected demand (e.g., mean (demand)−demand)) over a number of provisioning intervals (n). The example base workload forecaster 120 uses a dynamic programming solution to reduce a number of provisioning time intervals while reducing the sum of variances.

Σᵢ₌₁ⁿ(mean(demand([t₁₋₁),tᵢ]))−demand([tᵢ₋₁, tᵢ))²+(n−1) (1)

Solving the example equation (1) using a dynamic programming solution simultaneously reduces a number of provisioning changes to the data center 108 and a workload representation error as a difference between a base workload during a time interval and a representative workload pattern. In the example equation (1), the demand variable is a projected demand (e.g., the representative workload pattern) for each time interval. The number of time intervals may be expressed by example equation (2):

{[t₀, t₁]}, {[t₁, t₂]}, . . . , {[tₙ₋₁, tₙ]} (2)

In the example equation (2), the time period is defined as tₒ=0 and tₙ=86400 (i.e., the number of seconds in 24 hours). In other examples, the time period may be relative longer (e.g., a week) or relatively shorter (e.g., an hour). In this example, the example equation (1) is configured based on an assumption that the base workload is relatively constant. In other words, the example equation (1) is utilized based on an assumption that data center resources are not re-provisioned (i.e., added or removed) during a time interval.

After determining a number of time intervals to be provisioned, the example base workload forecaster 120 determines a base workload for each such time interval using the representative workload pattern. In some instances, example base workload forecaster 120 may determine a base workload for each time interval by determining an average of the representative workload pattern during the time interval. In other examples, the base workload may be determined by finding a 90% of peak (or other specific percentile of peak) workload demand of the representative workload pattern during the time interval. In yet other examples, data center operators may specify criteria for determining a base workload for a time interval based on the representative workload pattern.

Further, the example base workload forecaster 120 may determine thresholds in relation to the base workload for each time interval. The thresholds may indicate to the resource manager 116 when the second portion of resources 112 is to be utilized. In other words, the thresholds may instruct the resource manager 116 to prepare at least some of the resources B1-BN for processing workload before the capacity of the first portion of resources 110 is reached. In other examples, the thresholds may be the base workloads.

To provision the example first portion of resources 110, the example resource manager 116 of FIG. 1B includes a predictive controller 124. The example predictive controller 124 receives base workloads for time intervals determined by the base workload forecaster 120. To determine an amount of the first portion of resources 110 to be provisioned, the example predictive controller 124 determines a current time of the data center 108 and determines which time interval corresponds to the current time. For example, if the current time is 10:31 A.M., the example predictive controller 124 determines which time interval includes 10:31 A.M.

After determining the appropriate time interval, the example predictive controller 124 identifies the base workload for the time interval and determines an amount of resources of various type(s) that corresponds to the base workload. In some instances, the example predictive controller 124 may determine an amount of resources based on one or more type(s) of application(s) hosted by the resource(s) because different applications may have different response time targets (e.g., SLAs). For example, different amounts of resources may be provisioned by the predictive controller 124 for web searching, online shopping, social networking, and/or business transactions.

In some examples, the predictive controller 124 provisions resources within the data center 108 using, for example, queuing modeling theory. For example, an application hosted by the resources A1-AN and B1-BN of the illustrated example may have an SLA response time of t seconds, a mean incoming arrival rate of l jobs per second (e.g., workload), and a mean resource processing speed of u jobs per second. Based on this information, the predictive controller 124 may then solve example equation (3) to determine an amount of resources to provision.

$$\# resources = \frac{l}{u - \frac{1}{t}} \qquad ( 3 )$$

In other examples, the predictive controller 124 provisions resources based on other equation(s), algorithm(s), routine(s), function(s), or arrangement(s) specified by data center operators. In examples where resources are to concurrently host different type(s) of application(s), the example predictive controller 124 may apply different SLA requirements for each application type, and provision specific resource(s) for each application type. In other examples, the predictive controller 124 may aggregate and/or average SLA requirements for different applications type(s) and provision the first portion of resources 110 to host the different applications.

The example predictive controller 124 of FIG. 1B also changes provisioning of the first portion of resources 110 as time intervals change. After detecting a change (or an approaching change) in time intervals, the example predictive controller 124 identifies a base workload for the next time interval and determines an amount of the first portion of resources 110 to be provisioned. In examples where the next base workload includes more resources than the previous base workload, the example predictive controller 124 adds additional resources to the first portion of resources 110. To add additional resources, the example predictive controller 124 instructs the data center 108 to migrate some resources within the second portion of resources 112 to the first portion of resources 110. In other words, at the appropriate time (e.g., not too far in advance of the need for additional resources, but sufficiently early to be available when the expected need arrives) the predictive controller 124 of the illustrated example requests the data center 108 to activate an appropriate number of resources within the second portion of resources 112, thereby causing the newly activated resources to be logically included within the first portion of resources 110. Similarly, in examples where the next base workload includes fewer resources than the previous workload, the example predictive controller 124 determines a difference between the base workloads and (at the appropriate time) instructs the data center 108 to deactivate a number of resources within the first portion of resources 110 that corresponds to the difference. In this manner, the example predictive controller 124 ensures an appropriate number of resources are provisioned to correspond to a base workload for a current time interval.

The example predictive controller 124 of FIG. 1B monitors resource usage and sends an alert (e.g., a message) when an actual workload reaches a threshold related to the actual base workload for the current time interval. In some examples, the data center 108 transmits the alert to a reactive controller 126. The example alert causes the reactive controller 126 to provision some or all of the second portion of resources 112 to accommodate excess actual workload.

To provision the second portion of resources 112 for processing actual workloads that exceed base workloads for respective time intervals, the example resource manager 116 of FIG. 1B includes the reactive controller 126. The example workload monitor 118 monitors current actual demand and sends the actual workload to a coordinator 128. The example coordinator 128 compares the actual workload with the forecasted based workload and sends an alert when the actual workload demand exceeds a base workload during a fixed monitoring interval. The example reactive controller 126 receives the alert from the coordinator and provisions the second portion of resources 112 based on a detected excess workload.

The example alert instructs the reactive controller 126 to provision the second portion of the resources 112. The example alert may also inform the example reactive controller 126 about an amount of excess workload that exceeds a base workload for a time interval. In response to receiving an alert, the example reactive controller 126 determines an amount of resources to provision and instructs the data center 108 to provision those resources (e.g., from the second portion of resources 112). In other examples, the reactive controller 126 immediately provisions additional resources to proactively process relatively fast increases in actual workload. In this manner, the reactive controller 126 provisions resources from among the second portion of resources 112 that are used to process excess actual workload, thereby reducing energy costs while meeting SLA requirements and maintaining customer satisfaction.

When the actual workload recedes below a base workload during a time interval, the example reactive controller 126 of FIG. 1B receives an indication that the provisioned resources within the second portion of resources 112 can be deactivated. In some instances, the reactive controller 126 may also receive an indication that the processes and/or applications being hosted within the second portion of resources 112 are no longer in use. In these instances, the reactive controller 126 may wait for the indication so as to not terminate currently used services provided by the second portion of resources 112. By using excess resources to process excess demand, the example reactive controller 126 is able to reduce SLA violations during unexpected periods of relatively high workloads by provisioning extra resources to manage the excess workloads.

The reactive controller 126 of the illustrated example provisions the second portion of resources 112 in substantially the same manner as the predictive controller 124 provisions the first portion of resources 110. For example, the reactive controller 126 may use the example equation (3) to determine a number of resources to provision based on the excess actual workload.

To allocate actual workload among the portions of resources 110 and 112, the example resource manager 116 of FIG. 1B includes the coordinator 128. The example coordinator 128 receives requests (e.g., actual workloads) to access a service and/or application (e.g., resources within the data center 108) and determines to which of the portions of resources 110 and 112 the request is to be forwarded. In other examples, the coordinator 128 may respond to an originator of a request (e.g., the workstations 104) to identify to which resource the originator is to communicatively couple via, for example, the network 114.

The example coordinator 128 of FIG. 1B receives requests via, for example, the workload monitor 118. In other examples, the coordinator 128 may receive requests via a resource manager interface 130. The example coordinator 128 determines to which of the portions of resources 110 and 112 to forward a request by accessing a base workload for a current time interval and accessing the predictive controller 124 to determine an actual workload. In other examples, the coordinator 128 monitors the actual workload. If the actual workload is below a threshold and/or a base workload, the example coordinator 128 forwards the request (and/or responds to the request) to an appropriate (e.g., available) resource in the first portion of resources 110. If the actual workload is equal to and/or greater than a threshold, the example coordinator 128 forwards the request to the second portion of resources 112. Further, if the coordinator 128 detects that the actual workload is approaching a threshold (e.g., 90% of the base workload), the coordinator 128 may send an alert to the reactive controller 126.

The example coordinator 128 of the illustrated example determines when a threshold is exceeded by monitoring a number of requests received. In other examples, the coordinator 128 monitors an amount of bandwidth requested, an amount of bandwidth consumed, an amount of data transferred, and/or an amount of processor capacity being utilized. When an actual workload drops to below a threshold, the example coordinator 128 migrates workload from the second portion of resources 112 to the first portion of resources 110. The example coordinator 128 then instructs the reactive controller 126 to deactivate the second portion of resources 112.

To enable data center operators (and/or other personnel associated with the organization 102) to interface with the resource manager 116, the example resource manager 116 of FIG. 1B includes the resource manager interface 130. The example resource manager interface 130 enables data center operators to view historical data patterns stored in, for example, the data pattern database 122. The example resource manager interface 130 also enables data center operators to view and/or modify representative workload patterns, base workloads, and/or thresholds. Additionally, the example resource manager interface 130 enables data center operators to specify which equations, functions, algorithms, routines, and/or methods are to be used to determine a representative workload pattern, a base workload, a threshold, a number of time intervals, a time period length, and/or a number of resources to be provisioned based on a base workload, and/or an excess actual workload. The example resource manager interface 130 may also enable data center operators to manually provision resources among the first and second portions of resources 110 and 112.

The example resource manager interface 130 of FIG. 1B also receives request(s) to access resources within the data center 108 from, for example, the workstation(s) 104. In examples where a relatively large number of requests exceeds an amount of available resources, the example resource manager interface 130 of the illustrated example screens and/or filters the requests so that higher priority requests are processed to prevent the coordinator 128 and/or the data center 108 from becoming overloaded. In other examples, the resource manager interface 130 queues requests until the coordinator 128 is able to process the requests.

FIG. 1C shows the base workload forecaster 120 (e.g., a base workload processor) communicatively coupled to the predictive controller 124 and the reactive controller 126 of FIG. 1B. The example base workload processor 120 determines a base workload for the first portion of data center resources 110 based on a representative workload pattern. The base workload determined by the base workload processor 120 is substantially constant during time intervals. The example predictive controller 124 provisions the first portion of data center resources 110 to operate during the time intervals based on the determined based workload for the respective time intervals. The example reactive controller 126 configures the second portion of data center resources 112 to operate when an actual workload exceeds the base workload.

While an example manner of implementing the example system 100 has been illustrated in FIGS. 1A, 1B, and 1C one or more of the elements, processes and/or devices illustrated in FIGS. 1A, 1B, and 1C may be combined, divided, re-arranged, omitted, eliminated and/or implemented in any other way. Further, the example organization 102, the example workstations 104, the example server 106, the example data center 108, the example portions of resources 110 and 112, the example resource manager 116, the example workload monitor 118, the example base workload forecaster 120, the example data pattern database 122, the example predictive controller 124, the example reactive controller 126, the example coordinator 128, the example resource manager interface 130 and/or, more generally, the example system 100 of FIGS. 1A, 1B, and 1C may be implemented by hardware, software, firmware and/or any combination of hardware, software and/or firmware. Thus, for example, any or all of the example organization 102, the example workstations 104, the example server 106, the example data center 108, the example portions of resources 110 and 112, the example resource manager 116, the example workload monitor 118, the example base workload forecaster 120, the example data pattern database 122, the example predictive controller 124, the example reactive controller 126, the example coordinator 128, the example resource manager interface 130 and/or, more generally, the example system 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus claims of this patent are read to cover a purely software and/or firmware implementation, at least one of the example organization 102, the example workstations 104, the example server 106, the example data center 108, the example portions of resources 110 and 112, the example resource manager 116, the example workload monitor 118, the example base workload forecaster 120, the example data pattern database 122, the example predictive controller 124, the example reactive controller 126, the example coordinator 128, and/or the example resource manager interface 130 are hereby expressly defined to include a tangible computer readable medium such as a memory, DVD, CD, Blu-ray disc, memristor, etc. storing the software and/or firmware. Further still, the system 100 of FIGS. 1A and 1B may include one or more elements, processes and/or devices in addition to, or instead of, those illustrated in FIGS. 1A, 1B, and 1C, and/or may include more than one of any or all of the illustrated elements, processes and devices.

FIG. 2A shows the example resource manager 116 of FIGS. 1A and 1B provisioning the first and second portions of resources 110 and 112. In the illustrated example, the workload monitor 118 creates a representative workload pattern by analyzing data patterns 202-206. The example data patterns 202-206 show the workload (e.g., requests) measured during three different 24 hour time periods. In this example, the workload is measured as a number of received jobs per second. In other examples, the workload may be measured in bandwidth, resource capacity, data transfer, etc.

In the example of FIG. 2A, the example workload monitor 118 identifies repeating patterns among the data patterns 202-206 to create a representative workload pattern 207. The example representative workload pattern 207 is displayed in FIG. 2B for readability. In this example, the representative workload pattern 207 is an average of each time instance for the data patterns 202-206. In other examples, the representative workload pattern 207 may be a weighted average of the data patterns 202-206.

The example base workload forecaster 120 uses the representative workload pattern 207 to determine a number of intervals to create a base workload 208. In this example, the base workload forecaster 120 determines that the representative workload pattern 207 is to be partitioned into three time intervals 210-214 of different durations. In other examples, the base workload forecaster 120 may partition a representative data pattern into fewer or more time intervals. The example base workload forecaster 120 determines a number of time intervals in which provisioning is to occur to reduce a number of times the data center 108 is provisioned while reducing an error between the base workload 208 and the data patterns 202-206.

FIG. 2B shows the example base workload 208 of FIG. 2A in larger size for readability. In the example of FIG. 2B the base workload 208 is partitioned into the three time intervals 210-214 such that the base workload 208 approximately correlates with an average of the data patterns 202-206. For example, during the second time interval 212 (e.g., between around 7:00 A.M. and 5:30 P.M.), the base workload 208 indicates the first portion of resources 110 is to be provisioned for approximately 7000 requests per second, which substantially correlates to the data patterns 202-206 during the same time interval. Further, the example base workload 208 shows that the first portion of resources 110 is to remain constant during each of the time intervals 210-214.

In the example of FIG. 2A, the example predictive controller 124 uses the base workload 208 to determine a number resources (e.g., a number of servers) to provision the first portion of resources 110 within the data center 108 just prior to and/or at the start of one of the time intervals 210-214. For example, if the current time corresponds to right before the time interval 214 (e.g., 5:30 P.M.), the example predictive controller 124 identifies the base workload 208 during the time interval 214 (e.g., about 1200 requests per second) and determines a number of resources (e.g., 25 servers) that correspond to this base workload 208. The example predictive controller 124 then sends an instruction to the data center 108 to provision the determined number of resources as the first portion of resources 110.

In the illustrated example of FIG. 2A, the coordinator 128 receives an actual workload 220 from, for example, the workstations 104 of FIG. 1A. The example coordinator 128 determines the current time, identifies a time interval (e.g., the time intervals 210-214) associated with the current time (e.g., by accessing a lookup table), and identifies the base workload 208 for the time interval. The example coordinator 128 then compares the base workload 208 to the actual workload 220. In instances where the actual workload 220 exceeds the base workload 208, the example coordinator 128 sends an alert to the reactive controller 126 to provision additional resources 222 as the second portion of resources 112. The illustrated example shows that during some times (e.g., between about 6:00 A.M. and 11:00 A.M.) the reactive controller 126 does not provision the additional resources 222 because the actual workload 220 does not exceed the base workload 208.

In the example of FIG. 2A, the coordinator 128 partitions the actual workload 220 into an actual base workload 224 and an excess workload 226. The coordinator 128 partitions the actual workload 220 by identifying, for example, which requests are to be transmitted to the first portion of resources 110 as the actual base workload 224 and which requests cannot be adequately processed by the first portion of resources 110 and are transmitted to the second portion of resources 112 as the excess workload 226. The example coordinator 128 allocates the actual base workload 224 to the first portion of resources 110 and allocates the excess workload 226 to the second portion of resources 112. In this manner, the example coordinator 128 allocates the portion of the actual workload 220 that is equal to or less than the base workload 208 to resources that are already provisioned to process the actual base workload 224. Additionally, the example coordinator 128 allocates the portion of the actual workload 220 that is greater than the base workload 208 to resources that are provisioned by the reactive controller 126. Thus, the example resource manager 116 ensures SLA violations and energy are reduced by having resources on demand that can process the excess workload 226.

In the illustrated example, the data patterns 202-206 and workloads 208, 220, 224, and 226 are shown during a 24 hour time period to illustrate an example base workload 208 over time. In other examples, the base workload 208 and/or the data patterns 202-206 may be for relatively longer or shorter time periods. Additionally in many examples, the actual workload 220 is received in real-time by the coordinator 128 and allocated among the portions of resources 110 and 112 without specifically knowing previous and/or future actual workloads.

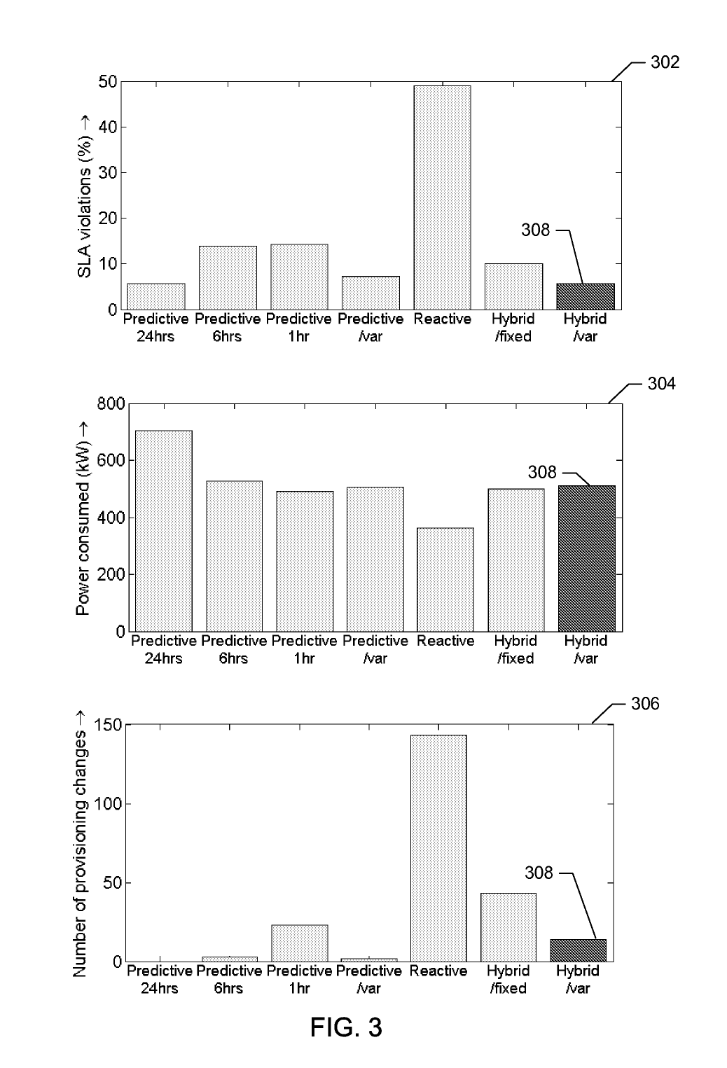

FIG. 3 shows graphs 302-306 showing example operational performance for the example resource manager 116 of FIGS. 1 and 2. In this example, the resource manager 116 was monitored during a five week period. Additionally, the resource manager 116 was configured to provision resources in a data center hosting an SAP enterprise application. In this example, the resources comprise a server configured for small and medium businesses. In other examples, the data center may host other types of applications and/or provision different resources.

The example graphs 302-306 show performances of the example resource manager 116 using the example method to provision resources among two portions of data center resources, as described herein. In the example graphs 302-306, the example method described herein is referred to as a hybrid-variable method 308. The example graphs 302-306 compare the example hybrid-variable method 308 of provisioning resources in a data center to other methods of provisioning resources. Non-limiting examples of methods to provision resources, and uses of the example methods, are described below.

The predictive 24 hours method (e.g., Predictive 24 hrs) provisions resources in the data center once every 24 hours. The predictive 6 hour method (e.g., Predictive 6 hrs) includes partitioning a 24 hour time period into four equal six hour time intervals and provisioning resources at the start of each interval. The predictive 1 hour method (e.g., Predictive 1 hrs) includes partitioning a 24 hour time period into 24 equal one hour time intervals and provisioning resources at the start of each interval. The predictive-variable method (e.g., Predictive/var) includes partitioning a 24 hour time period into a variable number of time intervals based on a day of the week and provisioning resources at the start of each interval. The reactive method (e.g., Reactive) monitors actual workload in ten minute time intervals and uses this information to provision resources for the next ten minutes. The hybrid-fixed (e.g., Hybrid/fixed) method includes partitioning a 24 hour time period into 24 equal one hour time intervals, provisioning resources at the start of each interval, and having a second portion of resources available when actual workload exceeds a base workload. These methods use a base workload for each time interval that is about 90% of a previously monitored peak workload during the respective time interval of a time period.

The example graph 302 of FIG. 3 illustrates a number of SLA violations as a percentage of actual workload received by the data center during the five week period. The example graph 302 shows that the percentage of SLA violations for the resource manager 116 using the hybrid-variable method 308 is about equal to the predictive 24 hour method and lower than the other methods. The example graph 304 illustrates an amount of power consumed by the different methods. In particular, the example graph 304 shows that the resource manager 116 using the example hybrid-variable method 308 has a power consumption lower than the predictive 24 hour method but about equal to the other methods. Thus, the example hybrid-variable method 308 has about the same number of SLA violations as the predictive 24 hour method but uses less power. The example hybrid-variable method 308 has the least amount of SLA violations among the other methods while having about the same power consumption.

The example graph 306 shows a number of provisioning changes during the five week period for each of the methods. In particular, the example hybrid-variable method has more provisioning changes than the predictive 24 hour method, the predictive 6 hour method, and the predictive-variable method, but fewer changes then the other methods. While the predictive 6 hour method and the predictive-variable method results in a data center having fewer provisioning changes than the example hybrid-variable method 308, a data center using the predictive 6 hour method and the predictive-variable method had more SLA violations than the example hybrid-variable method 308. Further, a data center using the example hybrid-variable method 308 consumed less power than a data center using the predictive 24 hour method. Thus, the example graphs 302-306 show that the example hybrid-variable method 308, utilized by the example resource manager 116 described herein, reduces SLA violations without increasing power consumption or a number of provisioning changes.

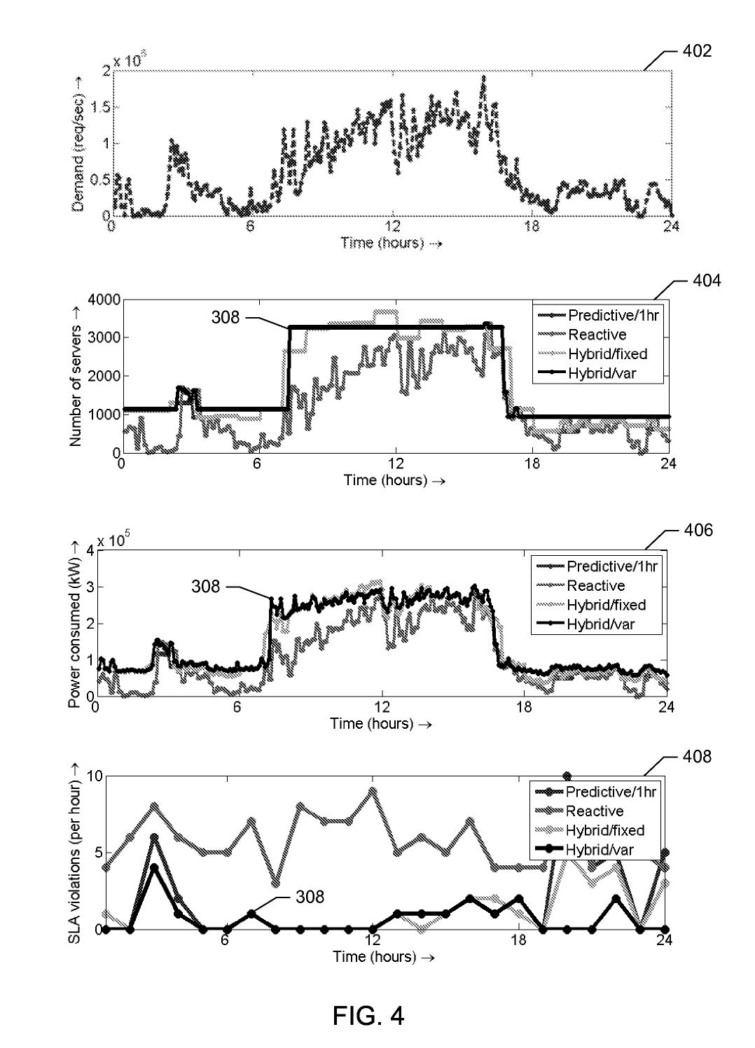

FIG. 4 illustrates graphs 402-408 of example operational performance for the example resource manager 116 of FIGS. 1 and 2. The example graphs 402-408 show performance of the resource manager 116 utilizing the example hybrid-variable method 308 compared to the predictive 1 hour method, the reactive method, and the hybrid-fixed method during a 24 hour time period. The example resource manager 116 was configured to provision resources hosting applications provided by a relatively large service provider.

The example graph 402 illustrates an actual workload over the 24 hour time period. In this example, the actual workload varied between 0 and 2 million requests per second. The example graphs 404-408 show the performance of the methods over the 24 time period based on the actual workload in the example graph 402. The example graph 404 shows a number of servers (e.g., resources) provisioned by the example hybrid-variable method 308 compared to the other methods. The example hybrid-variable method 308 includes a base workload that is partitioned into three time intervals (e.g., 0 to about 7 hours, 7 to about 17.5 hours, and 17.5 to 24 hours). The example graph 404 shows that the example hybrid-variable method 308 has the fewest provisioning changes among the measured methods while provisioning about a same number of servers as the predictive 1 hour method and the hybrid-fixed method.

The example graph 406 shows an amount of power consumed by the methods during the 24 hour time period. Similar to the results in the example graph 402, a data center using the example hybrid-variable method 308 consumed about the same amount of power as a data center using the predictive 1 hour method and the hybrid-fixed method while having substantially fewer provisioning changes than the other methods. The example graph 408 shows a number of SLA violations per hour for the each of the methods during the 24 hour time period. Similar to the results in the example graphs 402 and 404, the example hybrid-variable method 308 resulted in about the same number of SLA violations as the predictive 1 hour method and the hybrid-fixed method while having substantially fewer provisioning changes than the other methods. Further, while the example reactive method generally used fewer servers (as shown by the graph 404) and consumed less power (as shown by the graph 406), the example reactive method had more SLA violations than the example hybrid-variable method 308.

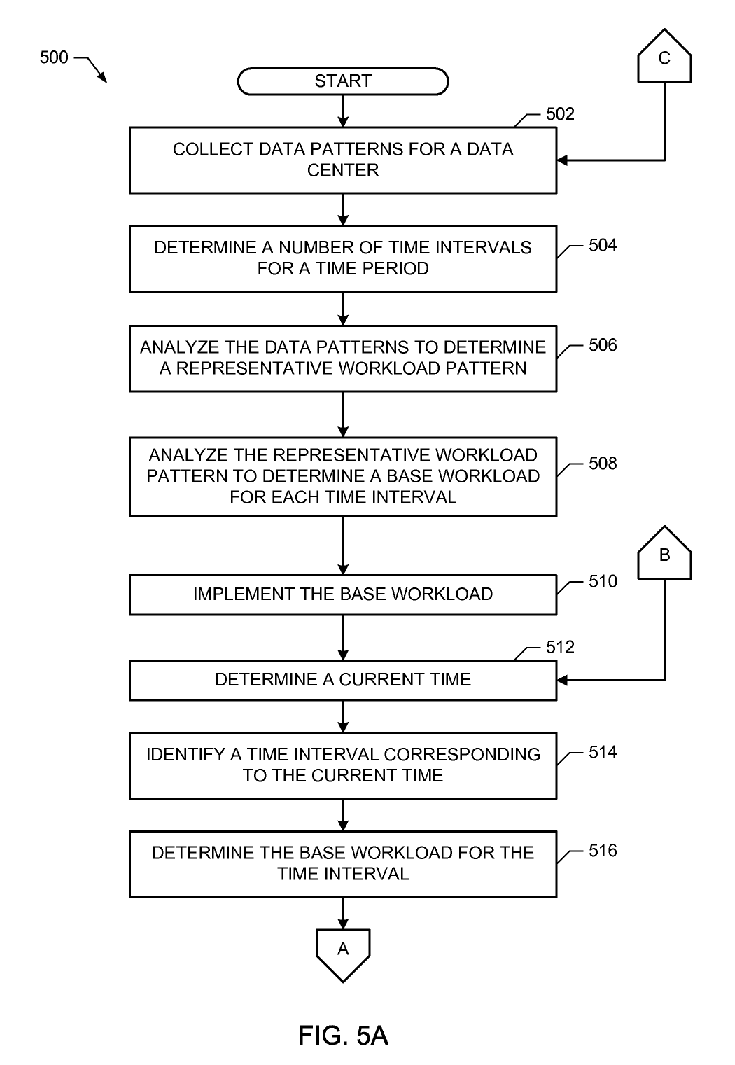

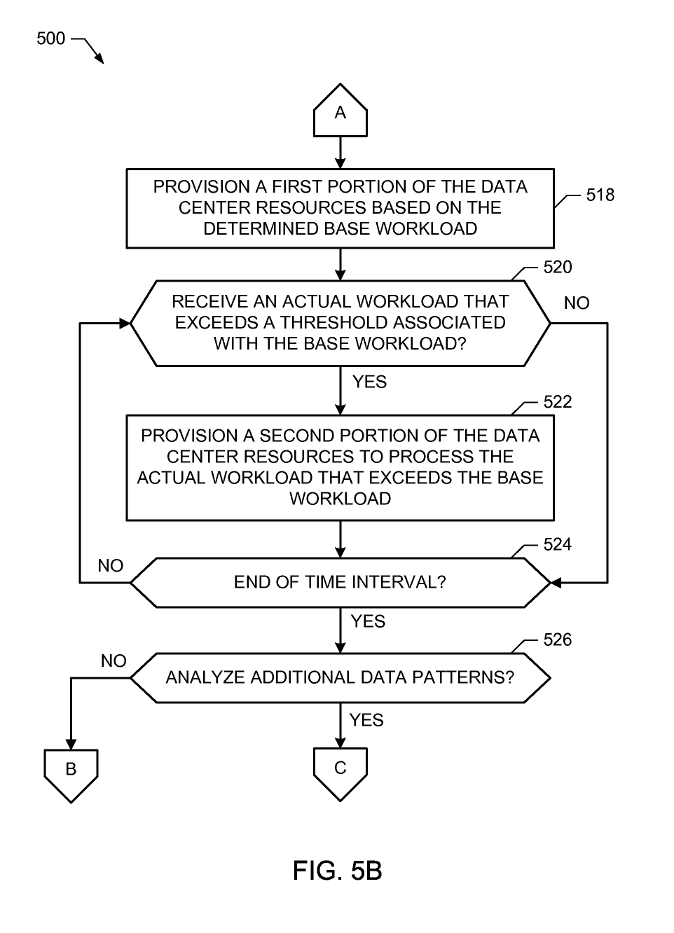

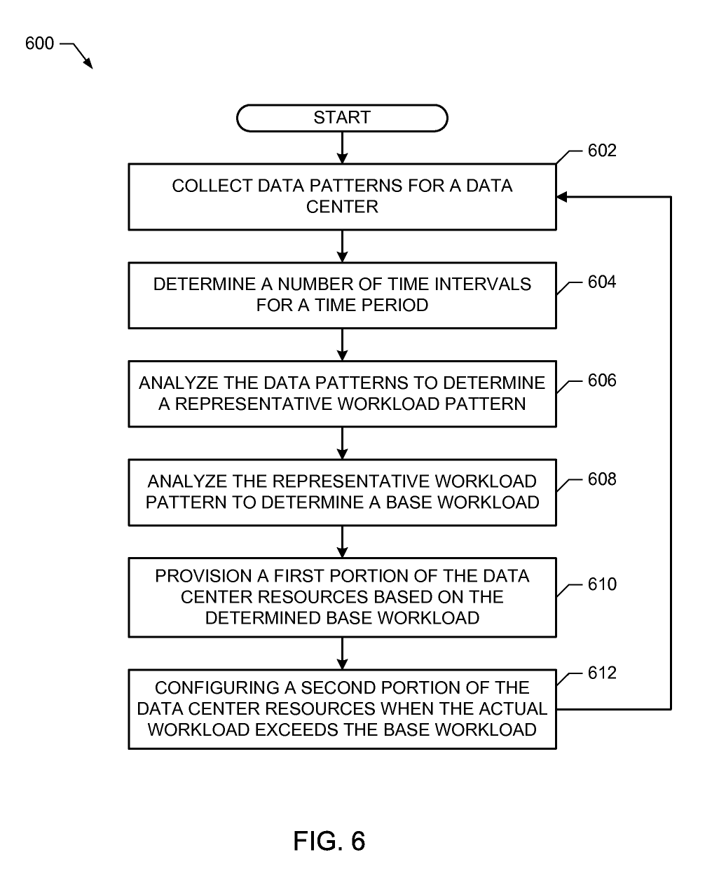

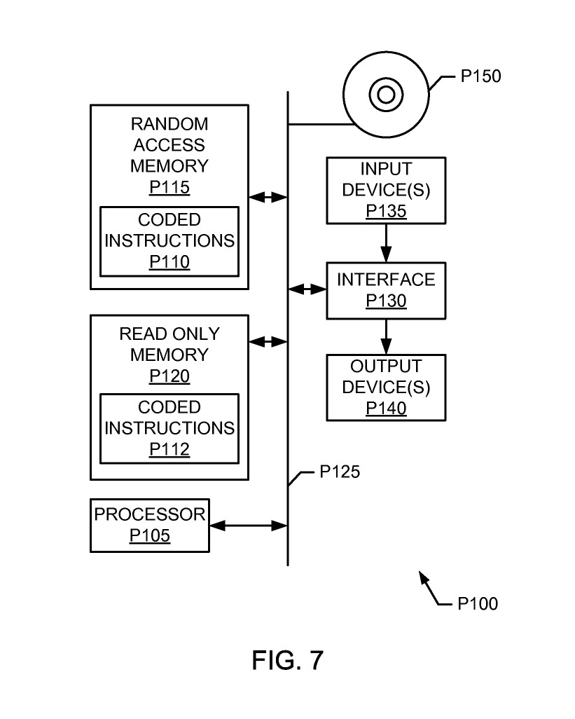

A flowchart representative of example machine readable instructions for implementing the resource manager 116 of FIGS. 1 and 2 is shown in FIGS. 5A, 5B, and 6. In this example, the machine readable instructions comprise a program for execution by a processor such as the processor P105 shown in the example processor platform P100 discussed below in connection with FIG. 7. The program may be embodied in software stored on a computer readable medium such as a CD, a floppy disk, a hard drive, a DVD, Blu-ray disc, a memristor, or a memory associated with the processor P105, but the entire program and/or parts thereof could alternatively be executed by a device other than the processor P105 and/or embodied in firmware or dedicated hardware. Further, although the example program is described with reference to the flowchart illustrated in FIGS. 5A, 5B, and 6, many other methods of implementing the example resource manager 116 may alternatively be used. For example, the order of execution of the blocks may be changed, and/or some of the blocks described may be changed, eliminated, or combined.

As mentioned above, the example machine readable instructions of FIGS. 5A, 5B, and 6 may be implemented using coded instructions (e.g., computer readable instructions) stored on a tangible computer readable medium such as a hard disk drive, a flash memory, a ROM, a CD, a DVD, a Blu-ray disc, a cache, a RAM and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 5A, 5B, and 6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The example machine-readable instructions 500 of FIG. 5A begin when example workload monitor 118 of FIG. 1B collects data patterns for a data center (e.g., the data center 108) (block 502). The example base workload forecaster 120 then uses the data patterns to determine a number of time intervals and a representative workload pattern for a time period (blocks 504 and 506). The example base workload forecaster 120 analyzes the representative workload pattern to determine a base workload for each time interval (block 508).

The example predictive controller 124 then implements the determined base workload for a data center (block 510). The example predictive controller 124 and/or the base workload forecaster 120 may also store the base workload to the example data pattern database 122. To provision resources, the example predictive controller 124 determines a current time and identifies a time interval that corresponds to the current time (blocks 512 and 514). The example predictive controller 124 then determines the base workload for the determined time interval (block 516).

The example predictive controller 124 then provisions a first portion of resources within the data center based on the determined base workload (block 518). The example coordinator 128 then receives an actual workload and determines if the actual workload exceeds the current base workload and/or a threshold associated with the base workload (block 520). If the base workload is exceeded, the example coordinator 128 instructs the example reactive controller 126 to provision a second portion of resources within the data center to process the actual workload that exceeds the threshold and/or the base workload (e.g., excess workload) (block 522). The example coordinator 128 and/or the predictive controller 124 then determines if a current time corresponds to (e.g., is within X minutes of) an end of the current time interval (block 524). Additionally, if the example coordinator 128 determines that there is no excess workload for the current time interval (block 520), the example coordinator 128 routes the requests for resources to the first portion of resources. The example coordinator 128 and/or the predictive controller 124 also determine if the current time corresponds to (e.g., is within X minutes of) an end of the current time interval (block 524).

If the current time interval is ending within a threshold time period (e.g., within 10 minutes. 5 minutes, 1 minute, etc), the example resource manager 116 determines if additional data patterns are to be monitored to create a new base workload (block 526). However, if the current time interval is not ending, the example coordinator 128 receives additional actual workloads and determines if the workloads exceed the base workload and/or associated threshold (block 520). If additional data patterns are to be collected, the example workload monitor 118 collects the additional data patterns to create a new representative workload pattern (block 502). If additional data patterns are not to be collected, the example predictive controller 124 determines a current time to provision the first portion of resources in the data center for the next time interval (block 512).

The example machine-readable instructions 600 of FIG. 6 begin when example workload monitor 118 of FIG. 1B collects data patterns for a data center (e.g., the data center 108) (block 602). The example base workload forecaster 120 then uses the data patterns to determine a number of time intervals and a representative workload pattern for a time period (blocks 604 and 606). The example base workload forecaster 120 analyzes the representative workload pattern to determine a base workload for each time interval (block 608).

The example predictive controller 124 next provisions a first portion of resources within the data center based on the determined base workload (block 610). The example coordinator 128 instructs the example reactive controller 126 to provision a second portion of resources within the data center to process the actual workload that exceeds the threshold and/or the base workload (e.g., excess workload) (block 612). The example workload monitor 118 may continue collecting data patterns to modify and/or adjust the representative workload pattern (blocks 602-606) based on workload changes.

FIG. 7 is a schematic diagram of an example processor platform P100 that may be used and/or programmed to execute the example machine readable instructions 500 of FIGS. 5A, 5B, and 6 to implement the example organization 102, the example workstations 104, the example server 106, the example data center 108, the example portions of resources 110 and 112, the example resource manager 116, the example workload monitor 118, the example base workload forecaster 120, the example data pattern database 122, the example predictive controller 124, the example reactive controller 126, the example coordinator 128, the example resource manager interface 130 and/or, more generally, the example system 100 of FIGS. 1A, 1B, 1C, and/or 2. One or more general-purpose processors, processor cores, microcontrollers, etc may be used to implement the processor platform P100.

The processor platform P100 of FIG. 7 includes at least one programmable processor P105. The processor P105 may implement, for example, the example organization 102, the example workstations 104, the example server 106, the example data center 108, the example portions of resources 110 and 112, the example resource manager 116, the example workload monitor 118, the example base workload forecaster 120, the example data pattern database 122, the example predictive controller 124, the example reactive controller 126, the example coordinator 128, the example resource manager interface 130 and/or, more generally, the example system 100 of FIGS. 1A and 1B. The processor P105 executes coded instructions P110 and/or P112 present in main memory of the processor P105 (e.g., within a RAM P115 and/or a ROM P120) and/or stored in the tangible computer-readable storage medium P150. The processor P105 may be any type of processing unit, such as a processor core, a processor and/or a microcontroller. The processor P105 may execute, among other things, the example interactions and/or the example machine-accessible instructions 500 of FIGS. 5A, 5B, and/or 6 to transfer files, as described herein. Thus, the coded instructions P110, P112 may include the instructions 500 of FIGS. 5A, 5B, and/or 6.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. The tangible computer-readable memory P150 may be any type of tangible computer-readable medium such as, for example, compact disk (CD), a CD-ROM, a floppy disk, a hard drive, a digital versatile disk (DVD), and/or a memory associated with the processor P105. Access to the memory P115, the memory P120, and/or the tangible computer-medium P150 may be controlled by a memory controller.

The processor platform P100 also includes an interface circuit P130. Any type of interface standard, such as an external memory interface, serial port, general-purpose input/output, etc, may implement the interface circuit P130. One or more input devices P135 and one or more output devices P140 are connected to the interface circuit P130.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent either literally or under the doctrine of equivalents.

What is claimed is:

1. A method to provision data center resources, comprising:
provisioning a first portion of data center resources to operate during time intervals based on a base workload for the respective time intervals, the base workload being based on data patterns of a data center; and
configuring a second portion of the data center resources to operate when an actual workload exceeds a threshold corresponding to the base workload.

2. A method as defined in claim 1, wherein the base workload identifies servers operating during corresponding ones of the time intervals.

3. A method as defined in claim 1, wherein the threshold corresponds to less than 100% of the base workload.

4. A method as defined in claim 1, further comprising determining a representative workload pattern based on the data patterns, the base workload being based on the representative workload pattern, the representative workload pattern being a weighted average of the data patterns with weights for the data patterns being selected using linear regression to reduce a sum-squared error of the representative workload pattern.

5. A method as defined in claim 1, wherein a number of the time intervals is determined by reducing a workload representation error and a number of workload changes.

6. A method as defined in claim 5, wherein the number of time intervals is selected to reduce a number of times the data center resources are provisioned.

7. A method as defined in claim 1, further comprising configuring the first portion of the data center resources to reduce power consumption of the data center.

8. An apparatus to provision data center resources, comprising:
a base workload processor to determine a base workload for a first portion of the data center resources based on a representative workload pattern, the base workload being substantially constant during time intervals;
a predictive controller to provision the first portion of the data center resources to operate during the time intervals based on the determined base workload for the respective time intervals; and
a reactive controller to configure a second portion of the data center resources to operate when an actual workload exceeds the base workload.

9. An apparatus as defined in claim 8, further comprising a workload monitor to determine data patterns of the data center to identify the representative workload pattern.

10. An apparatus as defined in claim 9, wherein the base workload processor is to determine the representative workload pattern by a weighted average of the data patterns for the time intervals with weights being selected for respective ones of the data patterns using linear regression to reduce a sum-squared error of the representative workload pattern.

11. An apparatus as defined in claim 8, wherein the predictive controller is to:
identify a current time of the data center;
determine a first time interval among the time intervals corresponding to the current time;
determine the first portion of the data center resources to be provisioned based on the base workload associated with the first time interval;
determine a current amount of the data center resources; and
if the current amount of the data center resources is less than the first portion of data center resources, activate additional ones of the first portion of the data center resources.

12. An apparatus as defined in claim 8, wherein the base workload processor is to determine the time intervals by:
solving a routine to reduce a workload representation error and a number of workload changes; and
resolving the solution of the routine with the representative workload.

13. An apparatus as defined in claim 8, further comprising a coordinator processor to:
determine a first portion of an actual workload that does not exceed the base workload and a second portion of the actual workload that is not included within the first portion; and
allocate the first portion of the actual workload to the first portion of the data center resources and allocate the second portion of the actual workload to the second portion of the data center resources.

14. A tangible article of manufacture storing machine-readable instructions that, when executed, cause a machine to at least:
determine a representative workload pattern during a time period based on data patterns of a data center, the time being period partitioned into time intervals;
determine a base workload for a first portion of the data center resources for the time intervals based on the representative workload pattern, the base workload being substantially constant during respective ones of the time intervals;
provision the first portion of the data center resources to operate during the time intervals based on the base workload; and
configure a second portion of the data center resources to operate when an actual workload exceeds a threshold corresponding to the base workload.

15. A tangible article of manufacture as defined in claim 14, wherein the machine-readable instructions, when executed, cause the machine to determine the representative workload pattern using a weighted average of the data patterns with weights for the data patterns being selected using linear regression to reduce a sum-squared error of the representative workload pattern.

16. A tangible article of manufacture as defined in claim 14, wherein the machine-readable instructions, when executed, cause the machine to determine a number of the time intervals by reducing a workload representation error and a number of workload changes to reduce the number of the time intervals.

17. A tangible article of manufacture as defined in claim 16, wherein the machine-readable instructions, when executed, cause the machine to determine the number of the time intervals to reduce an amount of energy consumed by the data center.

18. A tangible article of manufacture as defined in claim 16, wherein the machine-readable instructions, when executed, cause the machine to determine the number of the time intervals to reduce an amount of service level agreement violations by the data center.

19. A tangible article of manufacture as defined in claim 14, wherein the machine-readable instructions, when executed, cause the machine to:
identify a current time of the data center;
determine a first time interval among the time intervals corresponding to the current time;
determine the first portion of the data center resources to be provisioned based on the base workload associated with the first time interval;
determine a current amount of the data center resources;
if the current amount of the data center resources is less than the first portion of data center resources, activate additional ones of the first portion of the data center resources.

20. A tangible article of manufacture as defined in claim 14, wherein the machine-readable instructions, when executed, cause the machine to:
determine a first portion of an actual workload that does not exceed the base workload and a second portion of the actual workload that is not included within the first portion; and
allocate the first portion of the actual workload to the first portion of the data center resources and allocate the second portion of the actual workload to the second portion of the data center resources.
